(19) United States
(12) Patent Application Publication
(10) Pub. No.: US 2008/0239929 A1
(43) Pub. Date: Oct. 2, 2008

(54) OPTICAL HEAD DEVICE

(75) Inventors: Masaki Sasaki, Nagano (JP); Izumi Komatsu, Nagano (JP); Tadashi Takeda, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/059,063

(22) Filed: Mar. 31, 2008

(30) Foreign Application Priority Data
Mar. 30, 2007 (JP) JP2007-93484

(51) Int. Cl. G11B 7/135

(52) U.S. Cl. 369/112.24

(57) ABSTRACT

An optical head device may include a first laser light source, a second laser light source, a first parallel-plate type beam splitter for guiding a first and a second laser beams to a common objective lens, a second parallel-plate type beam splitter for guiding the second laser beam to the common objective lens, an aberration correction lens disposed between the first laser light source and the first beam splitter for correcting an aberration generated when the first laser beam transmits through the first beam splitter; and a light source unit which is structured by fixing the first laser light source and the aberration correction lens to a common holder in a state that a relative position between the first laser light source and the aberration correction lens is previously set.

### CROSS REFERENCE TO RELATED APPLICATION

The present invention claims priority under 35 U.S.C. §119 to Japanese Application No. 2007-93484 filed Mar. 30, 2007, which is incorporated herein by reference.

### FIELD OF THE INVENTION

An embodiment of the present invention may relate to an optical head device for performing reproduction and/or recording from and/or into an optical recording medium such as a CD or a DVD.

### BACKGROUND OF THE INVENTION

An optical head device which is used for performing reproduction and/or recording from and/or into an optical recording medium such as a CD and a DVD whose thicknesses are different from each other is provided with two sets of laser light sources whose wavelengths are different from each other. In the optical head device, a laser beam emitted from each of the laser light sources is guided to a common optical path and converged on an optical recording medium through a common objective lens. A return light beam component of the laser beam from the optical recording medium is separated from an emitted side laser beam on the common optical path and guided to a light receiving element. Two beam splitters are used in order to guide the respective laser beams to the common optical path and to separate the return light beam components of the respective laser beams from the emitted side laser beams. In Japanese Patent Laid-Open No. 2002-15456, a two-light source type optical pickup is disclosed in which two pieces of inexpensive parallel-plate type beam splitters are used as a beam splitter instead of a cube type beam splitter (prism).

In the optical pickup disclosed in the above-mentioned Patent Reference, a laser beam for CD recording and reproduction is reflected by a first parallel-plate type beam splitter and guided to an optical recording medium side, and a laser beam for DVD reproduction is reflected by a second parallel-plate type beam splitter and then transmits through the first beam splitter to be guided to the optical recording medium. Respective return light beam components of the laser beams reflected by the optical recording medium successively transmit both the beam splitters to be respectively guided to a light receiving element.

In an optical system in which each of the laser beams is guided to a common objective lens by using a parallel-plate type beam splitter and a return light beam component from an optical recording medium is separated from the emitted laser beam and is guided to a light receiving element, at least one of the laser beams is required to transmit the beam splitter. When a divergent laser beam which is emitted from a laser light source is transmitted through the parallel-plate type beam splitter in an oblique direction, astigmatism and coma aberration are generated and thus a satisfactory spot is not formed on an optical recording medium.

Therefore, in the above-mentioned Patent Reference, the beam splitter through which a laser beam directing to the optical recording medium is transmitted is made remarkably thinner than the other beam splitter to restrain generation of aberration. Further, in order to restrain generation of aberration due to bending of the beam splitter which is made thinner, the beam splitter is manufactured by using hard blank material.

In the optical pickup which is disclosed the above-mentioned Patent Reference, cost of the device is reduced by using a parallel-plate type beam splitter. However, in order to enhance quality of a light spot formed on an optical recording medium, a width of the parallel-plate type beam splitter through which the laser beam transmits obliquely is required to be made thinner. Therefore, a beam splitter with a general thickness and material such as the other general parallel-plate type beam splitter that is disclosed in the above-mentioned Patent Reference cannot be used and thus cost of the device is not reduced.

Further, even when the beam splitter is made thinner, astigmatism and coma aberration are generated when a laser beam for reproducing a DVD is obliquely transmitted through a parallel-plate type beam splitter. In the above-mentioned Patent Reference, in order to correct the astigmatism and coma aberration, an auxiliary lens provided with a cylindrical lens face is disposed on an emitting side of the laser light source. However, the auxiliary lens provided with the cylindrical lens face cannot correct the coma aberration. In order to correct coma aberration, the auxiliary lens is required to incline to an optical axis but, in this case, an extremely high degree of accuracy is required to align a laser light source with the auxiliary lens.

### SUMMARY OF THE INVENTION

In view of the problems described above, an embodiment of the present invention may advantageously provide an optical head device in which astigmatism and coma aberration generated when a laser beam transmits through a parallel-plate type beam splitter are corrected without reducing a thickness of the beam splitter so as to be capable of forming a satisfactory beam spot on an optical recording medium.

Thus, according to an embodiment of the present invention, there may be provided an optical head device including a first laser light source for emitting a first laser beam, a second laser light source for emitting a second laser beam whose wavelength is different from a wavelength of the first laser beam, a first parallel-plate type beam splitter which is disposed so as to guide the first and the second laser beams to a common objective lens and to guide a return light beam component reflected by an optical recording medium and returned through the common objective lens to a light receiving element, a second parallel-plate type beam splitter which is disposed so as to guide the second laser beam to the common objective lens and to guide the return light beam component reflected by an optical recording medium and returned through the common objective lens to the light receiving element, a device frame on which the first and the second laser light sources and the first and the second beam splitters are mounted, an aberration correction lens which is disposed between the first laser light source and the first beam splitter for correcting aberration generated when the first laser beam transmits through the first beam splitter, and a light source unit which is structured by fixing the first laser light source and the aberration correction lens to a common holder in a state that a relative position between the first laser light source and the aberration correction lens is previously set. The light source unit is adhesively bonded and fixed to a unit mounting part formed in the device frame in a positioned state, and the first laser beam which is emitted from the first laser light source is partially transmitted through the first beam splitter in an oblique direction to be guided to the objective lens, and the second laser beam which is emitted from the second laser light source is sequentially reflected by the second beam splitter and the first beam splitter to be guided to the objective lens. The astigmatism and coma aberration generated when the first laser beam transmits through the first beam splitter is corrected by the aberration correction lens which is disposed between the first laser light source and the first beam splitter.

In the optical head device in accordance with the embodiment of the present invention, only the first laser beam transmits obliquely through the first parallel-plate type beam splitter to reach to the optical recording medium and the second laser beam is reflected by the second and the first beam splitters in this order to reach to the optical recording medium. In this case, aberration generated in the first laser beam when the first laser beam transmits through the first beam splitter is corrected by the aberration correction lens which is disposed on the emitting side of the first laser light source. The first laser light source and the aberration correction lens are fixed to the common holder and structured as a light source unit in advance. Therefore, positioning between the first laser light source and the aberration correction lens can be performed with a high degree of accuracy and thus the aberration generated in the first laser beam is securely corrected. Accordingly, the first laser beam which has been transmitted through the beam splitter is converged on the optical recording medium as a satisfactory beam spot without using a parallel-plate type beam splitter which is formed of thin and hard material for restraining generation of aberration.

In accordance with an embodiment of the present invention, at least a piece of spacer is provided in the light source unit for adjusting a distance between a light-emitting point of the first laser light source and a lens center of the aberration correction lens, and at least one of the first laser light source and the aberration correction lens is fixed to the common holder through the spacer. This is because that there may occur a positional variation of a light-emitting point of the laser light source in its package or there may occur a variation of a distance between a lens center of the correction lens and its flange face for mounting the correction lens. Therefore, a variation may occur in a distance between the light-emitting point of the laser light source and the lens center of the correction lens when the laser light source and the correction lens are mounted on the common holder. According to the embodiment of the present invention, the above-mentioned variation is eliminated or restrained by providing the spacer and thus the laser light source and the correction lens are fixed to the common holder in the state that they are positioned each other with a high degree of accuracy.

In accordance with an embodiment of the present invention, the light source unit which is to be mounted on the unit mounting part is movable in a direction of an optical axis of the light source unit, in a direction perpendicular to the optical axis, and around an axial line perpendicularly passing through the optical axis. In addition, the light source unit is adhesively bonded and fixed to the unit mounting part in a state that position of the light source unit mounted on the unit mounting part has been three-dimensionally adjusted.

According to the embodiment described above, a residual aberration of the light source unit is securely eliminated by performing positional adjustment of the light source unit and thus a relative position between the light-emitting point of the light source unit and a light receiving face of the light receiving element can be set accurately.

In accordance with an embodiment of the present invention, each of the return light beam components of the first laser beam and the second laser beam is reflected by the first beam splitter to be guided to the second beam splitter and then transmits through the second beam splitter to be guided to the light receiving element.

Further, it is preferable to use a toric lens as the aberration correction lens. When a toric lens is used as the aberration correction lens, coma aberration generated when the first laser beam transmits through the first beam splitter can be corrected by inclination of a lens surface of the toric lens to a center optical axis of the first laser beam. In addition, astigmatism generated when the first laser beam transmits through the first beam splitter can be corrected by anisotropy of the radius of curvature of the lens surface of the toric lens. In this embodiment, it is preferable that the toric lens is provided with a function as a magnification conversion lens by which magnification from the first laser light source to the optical recording medium is set in a prescribed value.

In accordance with an embodiment of the present invention, an incident angle of the first laser beam to the first beam splitter is set at an inclination angle less than 45°. According to the structure as described above, the first laser beam is incident on the first beam splitter at an angle closer to the vertical incidence and thus a length of the optical path where the first laser beam transmits through the first beam splitter is shortened. Therefore, since the transmitting optical path is shortened, aberration generated when the first laser beam transmits through the first beam splitter can be reduced. Accordingly, a correction quantity of the aberration to be corrected by the correction lens is reduced and thus designing of the correction lens is easy.

The present invention may be applied to an optical head device which includes a single-laser light source. In other words, according to an embodiment of the present invention, there may be provided an optical head device including a laser light source for emitting a laser beam, a parallel-plate type beam splitter which is disposed so as to guide the laser beam to an objective lens, an aberration correction lens which is disposed between the laser light source and the beam splitter for correcting aberration generated when the laser beam partially transmits obliquely through the beam splitter, and a light source unit which is structured by fixing the laser light source and the aberration correction lens to a common holder in a state that a relative position between the laser light source and the aberration correction lens is previously set. The light source unit is adhesively bonded and fixed to a unit mounting part formed in a device frame in a positioned state, and the laser beam which is emitted from the laser light source is partially transmitted through the beam splitter in an oblique direction to be guided to the objective lens, and a return light beam component of the laser beam is reflected by the beam splitter to be guided to the light receiving element.

Also, in the single light source type optical head device in accordance with the embodiment of the present invention, the astigmatism and the coma aberration generated in the laser beam when the laser beam transmits through the parallel-plate type beam splitter can be corrected securely.

In accordance with an embodiment of the present invention, at least a piece of spacer is provided in the light source unit for adjusting a distance between a light-emitting point of the laser light source and a lens center of the aberration correction lens, and at least one of the laser light source and the aberration correction lens is fixed to the common holder through the spacer.

In accordance with an embodiment of the present invention, the light source unit which is to be mounted on the unit mounting part is movable in a direction of an optical axis of the light source unit, in a direction perpendicular to the optical axis, and around an axial line perpendicularly passing through the optical axis. In addition, the light source unit is adhesively bonded and fixed to the unit mounting part in a state that position of the light source unit mounted on the unit mounting part has been three-dimensionally adjusted.

Further, it is preferable that the aberration correction lens is a toric lens.

In accordance with an embodiment of the present invention, an incident angle of the laser beam to the beam splitter is set at an inclination angle less than 45°.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(A) is a plan view showing an optical head device in accordance with an embodiment of the present invention, FIG. 1(B) is its side view, and FIG. 1(C) is a bottom view showing the optical head device from which a bottom cover and like are detached.

FIG. 2 is a schematic optical structure view showing an optical system of the optical head device in FIGS. 1(A) through 1(C).

FIG. 3(A) is a perspective view showing a light source unit and FIG. 3(B) is its perspective cross-sectional view.

FIG. 4(A) is an exploded perspective view showing a light source unit which is viewed from its rear side, FIG. 4(B) is its exploded perspective view when the light source unit is viewed from its front side, and FIG. 4(C) is its exploded perspective view when the light source unit is cut along its optical axis.

### DETAILED DESCRIPTION OF THE PREFERRED EMBODIMENTS

An optical head device in accordance with an embodiment of the present invention will be described below with reference to the accompanying drawings.

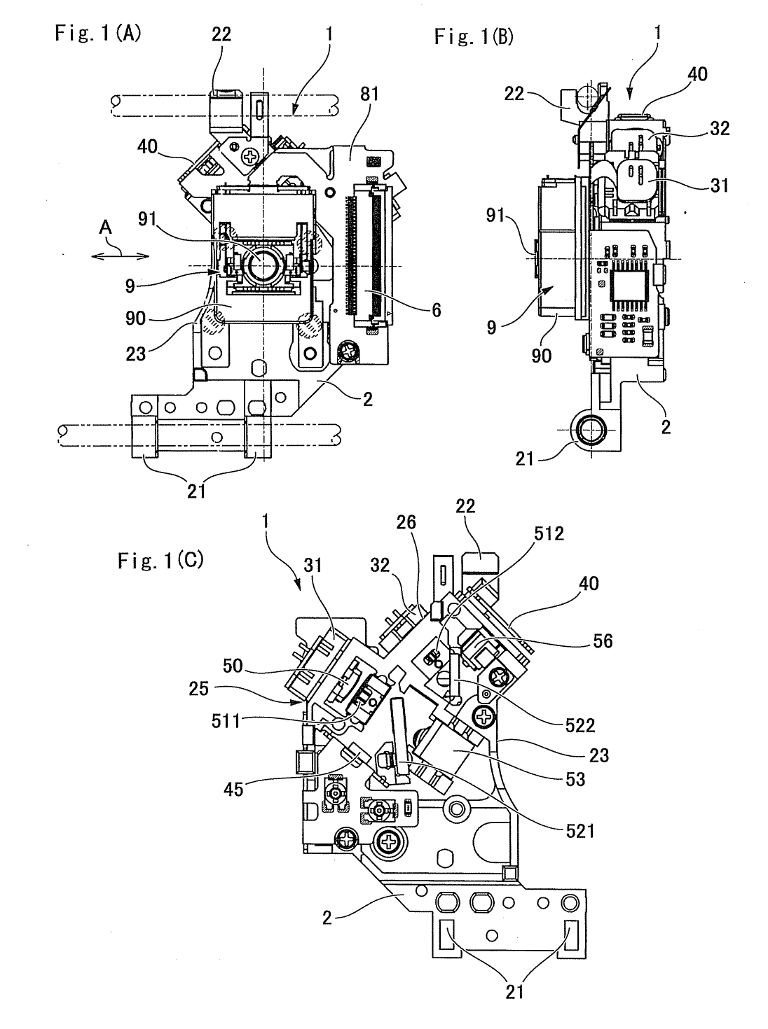

FIG. 1(A) is a plan view showing an optical head device in accordance with an embodiment of the present invention, FIG. 1(B) is its side view, and FIG. 1(C) is a bottom view showing the optical head device from which a bottom cover and like are detached. An optical head device 1 in this embodiment is a two-wavelength optical head device in which recording or reproduction of information into or from a CD system disk and a DVD system disk is capable of performing by using a first laser beam with a wavelength of 780 nm band and a second laser beam with a wavelength of 650 nm band.

The optical head device 1 includes a device frame 2 which is formed of a die casting product made of metal such as magnesium or zinc or which is made of resin. Respective ends of the device frame 2 are formed with a first bearing part 21 and a second bearing part 22 which are engaged with a guide shaft and a feed screw shaft (portions shown by the imaginary line in FIG. 1(A)) of a disk drive device. In this manner, the optical head device 1 is reciprocatingly movable in a radial direction of a disk as shown by the arrow “A”. A side face 23 of the device frame 2 in its movable direction is formed to curve in a circular arc-shape to prevent interference when the device frame 2 comes close to a spindle motor (not shown) of a disk drive mechanism.

An objective lens 91 is disposed at a roughly center portion on an upper face side of the device frame 2. Further, the device frame 2 is mounted with an objective lens drive mechanism 9 for servo-controlling a position of the objective lens 91 in a focusing direction and a tracking direction. In the optical head device 1 in this embodiment, recording and reproduction are performed with the first laser beam and the second laser beam through the common objective lens 91. Therefore, a two-wavelength lens on which a diffraction grating with concentric circular grooves or steps is formed is used as the common objective lens 91.

For example, in this embodiment, a wire suspension type mechanism, which is well known, is used for the objective lens drive mechanism 9. Detailed description of the objective lens drive mechanism 9 is omitted but the objective lens drive mechanism 9 includes a lens holder which holds the objective lens 91, a holder support portion which movably supports the lens holder in the tracking direction and the focusing direction with a plurality of wires, and a yoke which is fixed to the device frame 2. Further, the objective lens drive mechanism 9 is provided with a magnetic drive circuit which is structured of drive coils mounted on the lens holder and drive magnets which are mounted on the yoke. The objective lens 91 which is held on the lens holder is driven by controlling energization to the drive coils in the tracking direction and the focusing direction with respect to the optical recording medium. Further, the objective lens drive mechanism 9 is also capable of performing tilt control for adjusting inclination in a jitter direction of the objective lens 91. In this embodiment, surroundings of the objective lens 91 are covered with a rectangular frame-shaped actuator cover 90.

The device frame 2 is disposed with a flexible circuit board 81 on which a connector 6 and the like are mounted. Power supply, signal supply and the like are performed to the first and the second laser light sources 31 and 32 and the light receiving element 40 for signal detection through the flexible circuit board 81.

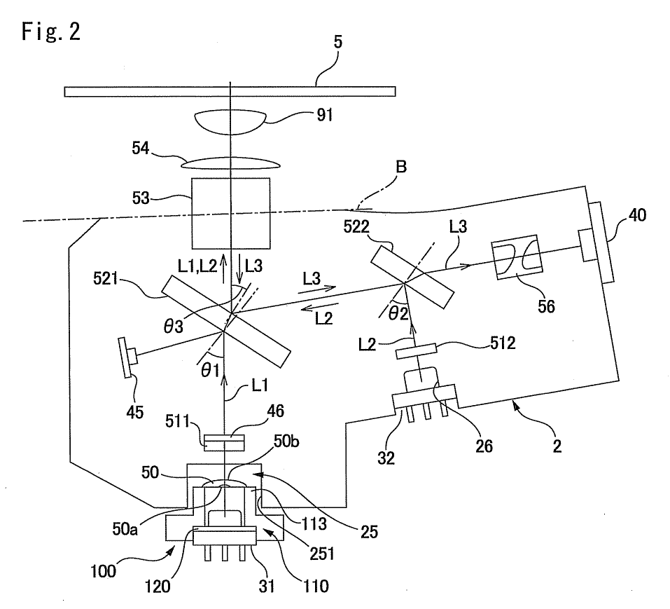

FIG. 2 is a schematic optical structure view showing an optical system of the optical head device 1. The upper portion from the position shown by the alternate long and short dash line “B” is a portion disposed in the direction which is perpendicular to the paper but, in FIG. 2, the upper portion is shown in a flatly developed state.

As shown in FIG. 1(C) and FIG. 2, a portion of the device frame 2 on an opposite side face to the side face formed to be curved in a circular arc-shape is mounted with the first laser light source 31 provided with an AlGaInP-based laser diode for emitting the first laser beam and the second laser light source 32 provided with an AlGaAs-based laser diode for emitting the second laser beam. The first laser light source 31 is structured as one unit and mounted to a unit mounting part 25 which is formed in the device frame 2. After positional adjustment of the first laser light source 31 is performed, the first laser light source 31 is adhesively bonded and fixed to the device frame 2. On the other hand, the second laser light source 32 is press-fitted and fixed to a press fitting part 26 which is formed in the device frame 2.

A first forward path “L1” along which the first laser beam is guided to a recording face of the optical recording medium 5 from the first laser light source 31 and a second forward path “L2” along which the second laser beam is guided to the recording face of the optical recording medium 5 from the second laser light source 32 are formed as optical paths for the first and the second laser beams. Further, a return path “L3” is formed along which a return light beam which is reflected by the recording face of the optical recording medium 5 is guided to the light receiving element 40 for signal detection.

On the first forward path “L1” are disposed a first diffraction grating 511 for diffracting the first laser beam emitted from the first laser light source 31 to three beams for tracking detection, a first parallel-plate type beam splitter 521 for partially transmitting the laser beams divided into three beams by the first diffraction grating 511, and a directing mirror 53 for directing the laser beams transmitting through the first beam splitter 521 upward to the optical recording medium 5. A collimating lens 54 for forming the laser beam into a parallel light and the objective lens 91 for converging the parallel light from the collimating lens 54 on the recording face of the optical recording medium 5 are disposed on an upper position of the directing mirror 53.

On the second forward path “L2” are disposed a second diffraction grating 512 for diffracting the second laser beam emitted from the second laser light source 32 into three beams for tracking detection and a second parallel-plate type beam splitter 522 for partially reflecting the laser beams divided into three beams by the second diffraction grating 512.

The first parallel-plate type beam splitter 521 is used as an optical path composite element for composing the first forward path “L1” and the second forward path “L2”. The laser beam which is reflected by the second beam splitter 522 is partially reflected by the first beam splitter 521 and then, similarly to the first laser beam, the laser beam is irradiated on the recording face of the optical recording medium 5 through the directing mirror 53, the collimating lens 54 and the objective lens 91. Therefore, an optical path from the first beam splitter 521 to the optical recording medium 5 is structured as a common optical path.

The return light beam along the return path “L3” returns to the first beam splitter 521 through the common optical path. After the return light beam is reflected by the first beam splitter 521, the return light beam transmits through the second beam splitter 522 and then, an astigmatism is applied to the return light beam by the detection lens 56 and the return light beam reaches to the light receiving element 40 for signal detection.

In this embodiment, as shown in FIG. 1(C) and FIG. 2, a light receiving element 45 for monitor is disposed at a vicinity position of an incident face of the first beam splitter 521 to which the first laser beam is incident. A reflected light component of the first laser beam which is partially reflected by the incident face of the first beam splitter 521 is received with the light receiving element 45 for monitor and, on the basis of a quantity of the received light, an emission intensity of the first laser light source can be feedback-controlled.

Therefore, the first beam splitter 521 in this embodiment is provided with an optical characteristic that substantially 50% of the first laser beam is transmitted and substantially 50% is reflected and that the second laser beam is substantially totally reflected. The second beam splitter 522 is provided with an optical characteristic that the first laser beam is substantially totally transmitted and substantially 50% of the second laser beam is transmitted and substantially 50% is reflected.

An aberration correction lens 50 for correcting aberration is disposed between the first laser light source 31 and the first diffraction grating 511 on the first forward path “L1”. The aberration correction lens 50 is a lens for correcting aberrations (coma aberration and astigmatism) which are generated when the first laser beam emitted from the first laser light source 31 is obliquely transmitted through the first beam splitter 521 as a divergent beam. A toric lens is, for example, used as the aberration correction lens 50. The toric lens is structured so that a lens face on a side of the first laser light source 31 is formed to be a concave face 50a and a lens face on the other side is formed to be a toric face 50b. In this embodiment, as described below, the first laser light source 31 and the aberration correction lens 50 are fixed to a common holder 110 to structure a light source unit 100. The light source unit 100 is mounted on a unit mounting part 25 of the device frame 2.

The aberration correction lens 50 (toric lens) is disposed in an inclined state by a specified angle with respect to an emitting beam axis of the first laser light source 31. In other words, the concave face 50a and the toric face 50b are inclined by the specified angle with respect to the optical axis of the emitted light beam of the first laser light source 31. Therefore, the aberration correction lens 50 generates coma aberration in a reverse direction to the coma aberration, which is generated when the first laser beam transmits through the first beam splitter 521, by the inclinations of the concave face 50a and the toric face 50b with respect to the optical center axis of the first laser beam. As a result, the coma aberration generated when the first laser beam transmits through the first beam splitter 521 is corrected. Further, the aberration correction lens 50 generates coma aberration in a reverse direction to the astigmatism, which is generated when the first laser beam transmits through the first beam splitter 521, by anisotropy of radius of curvature of the toric face 50b. As a result, the astigmatism generated when the first laser beam transmits through the first beam splitter 521 is corrected.

In this embodiment, an optical magnifying power in the second forward path “L2” directing to an optical recording medium 5 from the second laser light source 32 is, for example, set to be 6.5-7.5 times (in a range from 6.5 times to 7.5 times). On the other hand, an optical magnifying power in the first forward path “L1” directing to the optical recording medium from the first laser light source 31 is, for example, preferably set to be 3.5-5.0 times (in a range from 3.5 times to 5.0 times). However, in the first forward path “L1” and the second forward path “L2”, the collimating lens 54 and the objective lens 91 are commonly used and, in addition, there is a limitation on layout. Therefore, the toric lens which is used as the aberration correction lens 50 is used as a magnifying power conversion lens for the first laser beam and the optical magnifying power in the first forward path “L1” directing to the optical recording medium 5 from the first laser light source 31 is optimized by the aberration correction lens 50 (toric lens).

Further, an incident angle θ1 of the first laser beam to the first beam splitter 521 is set at an inclination angle of less than 45°. For example, the incident angle θ1 is set at 40°. Therefore, a length of an optical path where the first laser beam transmitting through the first beam splitter 521 can be shortened and thus aberration, which is generated when the first laser beam transmits through the first beam splitter 521, becomes smaller by a quantity of the incident angle which is set to be nearer to the vertical incidence to the first beam splitter 521. In this embodiment, the incident angle θ2 of the second laser beam to the second beam splitter 522 is set to be 45°. However, an incident angle θ3 of the second laser beam to the first beam splitter 521 is set to be the same angle as the incident angle θ1 of the first laser beam to the first beam splitter 521, for example, set to be at 40°.

The diffraction grating 511 for generating three beams which is disposed on the first forward path “L1” is integrally formed with a ½-wavelength plate 46 on its emitting side face. A direction of polarization plane of the first laser beam emitted from the first laser light source 31 is adjusted by the ½-wavelength plate 46 and set in the direction which is inclined at 45 degrees to a perpendicular plane of the reflection face including the incidence and the reflection directions when the first laser beam is incident on the reflection face 53a of the directing mirror 53. The reflection face 53a of the directing mirror 53 is designed so that phase differences occurred when both the laser beams are reflected are set to be p (2n+1)/2 (n=0, 1, 2 . . . ). Therefore, both the laser beams incident on the reflection face 53a of the directing mirror 53 in a state that directions of the polarization planes are inclined at 45 degrees are converted into a circularly polarized light after reflection. Information reading performance is improved by forming a beam spot on an optical recording medium 5 close to a circularly polarized light.

Beam spots of the first and the second laser beams on the optical recording medium 5 are formed in an elliptic shape and directions of the ellipses are set to have an angle difference so that the respective laser beams are optimized. For example, a major axis of the elliptic beam spot of the second laser beam for a DVD system disk is set, for example, at an angle of −10 degrees with respect to a radial direction (direction shown by the arrow “A” in FIG. 1(A)) of the optical recording medium 5. On the other hand, a major axis of the elliptic beam spot of the first laser beam for a CD system disk is set, for example, at an angle of +30 degrees with respect to the radial direction of the optical recording medium 5. It has been qualitatively known that as the angle formed between a major axis of the elliptic beam spot and the radial direction of the optical recording medium becomes smaller, jitter performance becomes superior but a cross talk with adjacent tracks becomes inferior. Therefore, it is commonly designed that the angle of the beam spot of the first laser beam for a CD system disk is set to be larger than that of the beam spot of the second laser beam for a DVD system disk with respect to the radial direction of the optical recording medium 5 to give priority to cross talk reduction with adjacent tracks.

The angle of the elliptic beam spot is required to be optimally designed according to application of the optical head device 1, for example, according to characteristics considered important such as a cross talk with adjacent tracks, a jitter performance, a track cross signal performance at the time of seeking, an effective spot size at the time of recording.

In order to function both the laser beams as a circularly polarized light while using the common directing mirror 53, both the laser beams are required to be designed that polarization planes of the respective laser beams are incident at an angle of 45 degrees to the reflection face of the directing mirror 53. In this embodiment, the second laser light source 32 is press-fitted and fixed to the device frame 2 in a state that its position is adjusted around the optical axis of the second laser light source 32 so that the polarization plane direction of the second laser beam in an emitted state is incident on the reflection face of the directing mirror 53 at 45 degrees.

On the other hand, the first laser light source 31 is mounted on the device frame 2 in a state that its polarized light direction is adjusted so that the elliptic beam spot “P1” on the optical recording medium 5 of the first laser beam emitted from the first laser light source 31 is set to be at the angle of +30 degrees with respect to the radial direction. Therefore, in this situation, the polarization plane direction is not incident at the angle of 45 degrees to the reflection face of the directing mirror 53 and thus the first laser beam cannot be converted into a circularly polarized light by the directing mirror 53.

In this embodiment, the angle which is required for the major axis direction of the elliptic beam spot on the optical recording medium 5 is different from the angle of the polarization plane direction (45 degrees) at the time of incidence of the laser beam to the directing mirror 53. Therefore, the ½-wavelength plate 46 is disposed between the first laser light source 31 and the directing mirror 53 for adjusting the polarization plane direction of the first laser beam emitted from the first laser light source 31 so that the polarization plane direction is incident on the directing mirror 53 at the angle of 45 degrees.

In this embodiment, the ½-wavelength plate 46 is integrally formed with the diffraction grating 511 to reduce cost.

Next, the light source unit 100 will be described in detail below. As described above, the aberration correction lens 50 for correcting aberration which is generated when the first laser beam transmits through the first beam splitter 521 corrects astigmatism and coma aberration and, in addition, the aberration correction lens 50 is provided with a magnifying power conversion function to enhance utilization efficiency of light while using the common collimator lens 54. Further, a so-called toric lens in which an aspherical surface of rotation is inclined is used as the aberration correction lens 50. Therefore, when a distance between the light emitting point of the first laser light source 31 and the lens center of the aberration correction lens 50 is not adjusted accurately, and when the inclination of the aberration correction lens 50 is not adjusted accurately, a desired effect of aberration correction cannot be obtained and thus a satisfactory beam spot cannot be formed on the optical recording medium 5.

Therefore, in this embodiment, the first laser light source 31 and the aberration correction lens 50 are assembled into a common holder 110 to structure the light source unit 100. The light source unit 100 is mounted on a unit mounting part 25 which is formed in the device frame 2 and is adhesively bonded and fixed to the device frame 2 in a state where its position has been adjusted.

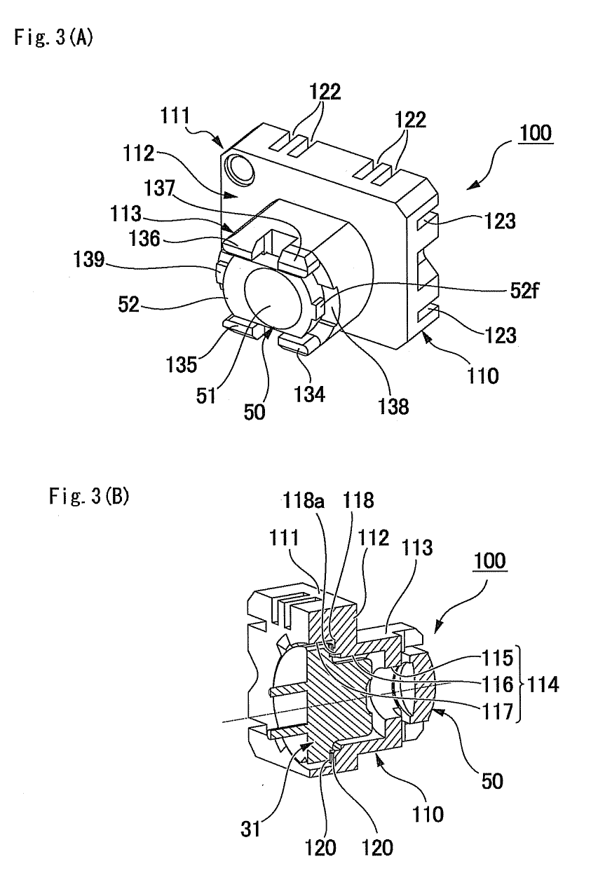

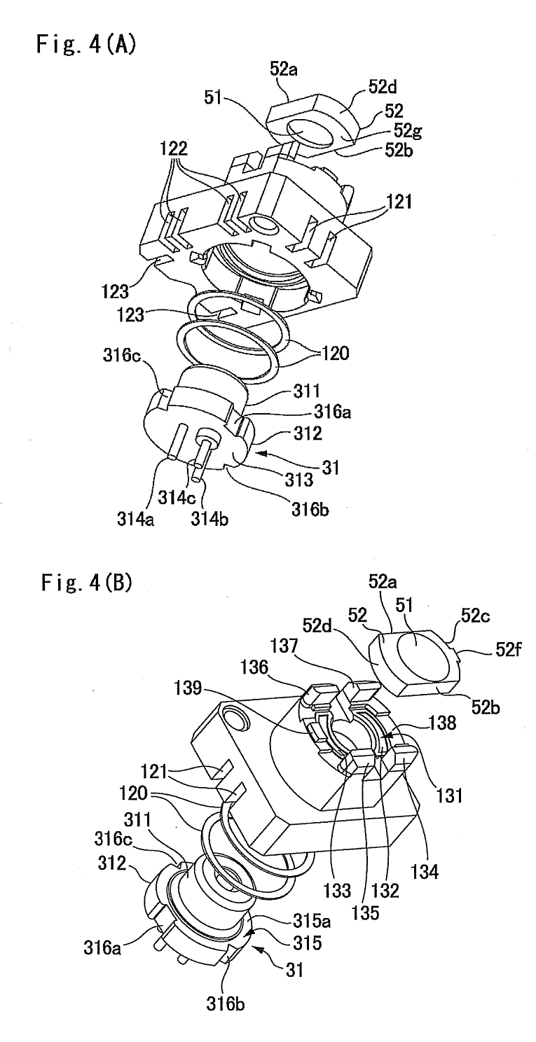

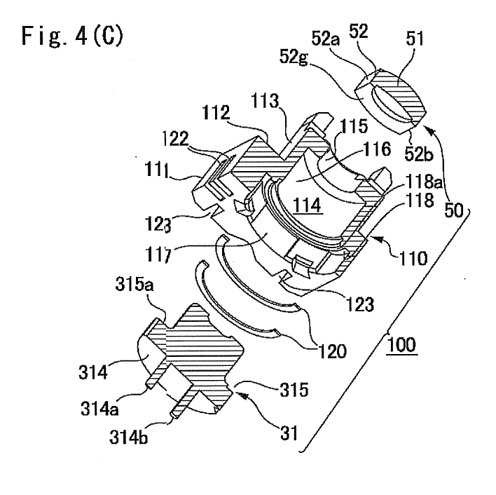

FIG. 3(A) is a perspective view showing the light source unit and FIG. 3(B) is its perspective cross-sectional view. FIG. 4(A) is an exploded perspective view showing the light source unit when viewed from its rear side, FIG. 4(B) is its exploded perspective view when viewed from its front side, and FIG. 4(C) is its exploded perspective view when the light source unit is cut along its optical axis. A structure of the light source unit will be described below with reference to these drawings.

The light source unit 100 includes the holder 110, the aberration correction lens 50 which is adhesively bonded and fixed to the holder 110, the first laser light source 31 which is adhesively bonded and fixed to the holder 110, and at least a spacer ring 120 which is appropriately mounted for adjusting a distance between the aberration correction lens 50 and the first laser light source 31. On a case-by-case basis, the spacer ring 120 is not mounted, or three or more pieces of the spacer ring 120 are mounted.

As shown in FIG. 3(B) and FIG. 4(C), the holder 110 includes a rectangular flange 111 and a tubular shaped part 113 which protrudes forward in a perpendicular direction from a front face 112 of the flange 111. A through hole 114 in a circular cross section is formed in these center portions. The through-hole 114 is formed so that its front end portion is formed to be a small diameter hole portion 115, its rear side is formed to be a middle diameter hole portion 116 which is larger than the small diameter hole portion 115, and its rear side is formed to be a large diameter hole portion 117. A circular ring-shaped step face 118 facing backward is formed between the middle diameter hole portion 116 and the large diameter hole portion 117. A circular ring-shaped protruding face 118a protruding a little rearward is formed on the circular ring-shaped step face 118.

As shown in FIGS. 4(A) and 4(B), the first laser light source 31 includes a cylindrical case 311 and a large diameter disk-shaped flange 312 which is continuously formed in a rear end part of the cylindrical case 311. A laser diode is enclosed in the inside of the cylindrical case 311. Three lead terminals 314a through 314c are perpendicularly protruded to rearward from a rear end face 313 of the disk-shaped flange 312. A circular ring-shaped step face 315 facing forward is formed between the cylindrical case 311 and the disk-shaped flange 312. A circular ring-shaped end face 315a which is retreated rearward is formed on an outer peripheral side of the circular ring-shaped step face 315.

The cylindrical case 311 and the disk-shaped flange 312 of the first laser light source 31 are respectively press-fitted and fixed to the middle diameter hole portion 116 and the large diameter hole portion 117 of the holder 110 from rear side. In addition, for example, two spacer rings 120 are mounted between the circular ring-shaped end face 315a of the first laser light source 31 and the circular ring-shaped protruding face 118a of the holder 110 in a sandwiched state.

An outer peripheral face of the disk-shaped flange 312 of the first laser light source 31 is formed with three tool engaging grooves 316a through 316c at a prescribed angular interval each of which is cut out to its inner side. The position of the first laser light source 31 which is press-fitted to the holder 110 is capable of being adjusted, for example, by turning around its optical axis with the use of the tool engaging grooves 316a through 316c. Similarly, tool engaging grooves 121 through 123 are formed on three outer peripheral faces and an end face of the flange 111 on the rear side of the holder 110.

The aberration correction lens 50 includes a circular main lens body portion 51 and an oblong flange part 52 surrounding its outer periphery. The flange part 52 is formed so that end faces 52a and 52b on its long side are extended in parallel to each other and end faces 52c and 52d on its short side are formed in a circular arc face with the lens center as a center. In addition, a projection 52f for positional adjustment which protrudes on an outer side is formed on the end face 52c.

A front end part of the holder 110 is formed with a lens mounting part on which the aberration correction lens 50 structured as described above is mounted. The lens mounting part is formed with a shallow mounting groove part 131 having a shape corresponding to an outline shape of the flange part 52 of the aberration correction lens 50. The mounting groove part 131 is formed with a pair of circular arc grooves 132 and 133, which are formed deeper from the mounting groove part 131, for filling an adhesive. Further, two projections 134, 135 and 136, 137 are respectively protruded forward from a front end face of the holder so as to face the end faces 52a and 52b of the long sides of the aberration correction lens 50 which is mounted on the mounting groove part 131. In addition, a recessed part 138 for allowing a tool to engage with the projection 52f from one side is formed on a portion of the mounting groove part 131 which faces the projection 52f for positional adjustment of the aberration correction lens 50. A guiding projection 139 provided with an inner circular arc-shaped peripheral face which is capable of abutting with the circular arc-shaped end face 52d of the aberration correction lens 50 is formed on an opposite side to the recessed part 138 of the mounting groove part 131.

The aberration correction lens 50 which is to be mounted on the lens mounting part structured as described above from the front side is put on the mounting groove part 131, the circular arc-shaped end face 52d is pressed against the guiding projection 139 and, in this state, positional adjustment of the aberration correction lens 50 has been performed by using the projection 52f for positional adjustment and then the aberration correction lens 50 is adhesively bonded and fixed to the front end part of the holder.

When the holder 110 has been manufactured with a high degree of accuracy, the first laser light source 31 and the aberration correction lens 50 are adhesively fixed in an accurate state where their optical axes are matched with a high degree of accuracy. Further, a distance between the light-emitting point of the first laser light source 31 and the lens center of the aberration correction lens 50 can be adjusted with a high degree of accuracy. In other words, variation may occur in the distance between the light-emitting point and the circular ring shaped step face 315 of the disk-shaped flange 312 in the first laser light source 31. Further, variation may occur in the distance between the lens center and the rear end face 52g of the flange part 52 which is its outer periphery of the aberration correction lens 50. When variations occur in these distances, variation occurs in a distance between the first laser light source 31, which is positioned by the circular ring shaped step face 315 with respect to the holder 110 in an optical axis direction, and the aberration correction lens 50 which is positioned by the rear end face 52g of the flange part 52 with respect to the holder 110 in the optical axis direction. In this embodiment, the above-mentioned variation is absorbed by mounting the spacer ring 120 and thus these parts 31 and 50 are fixed to the holder 110 in the state that positioning in the optical axis direction is performed with a high degree of accuracy.

Next, the light source unit 100 having the structure as described above is mounted on the unit mounting part 25 formed in the device frame 2 in a state with a play and, after positional adjustment has been performed in three dimensional directions, the light source unit 100 is adhesively bonded and fixed to the unit mounting part 25.

In other words, in FIG. 2, the device frame 2 is formed with a fitting hole 251 to which the tubular shape part 113 on the front side of the light source unit 100 is capable of fitting. The fitting hole 251 is provided with an inner peripheral face which has a similar shape larger than the outline shape of the cylindrical part 113. Therefore, the light source unit 100 which is to be mounted on the fitting hole 251 is movable in the optical axis direction. Further, the light source unit 100 is also movable within a prescribed range in the direction perpendicular to the optical axis direction. In addition, the light source unit 100 is also capable of inclining around an axial line passing through the optical axis in a perpendicular direction. As described above, the light source unit 100 is mounted on the fitting hole 251 in the state that its position is capable of being three-dimensionally adjusted and then position of the light source unit 100 is adjusted by using a tool for positional adjustment. An adhesive is applied after the positional adjustment has been performed and then the light source unit 100 is adhesively bonded and fixed to the device frame 2.

As described above, in the optical head device 1 in accordance with this embodiment, the first parallel-plate type beam splitter 521 is used as an optical path composing element which partially transmits the first laser beam emitted from the first laser light source 31 and partially reflects the second laser beam emitted from the second laser light source 32. Further, the second parallel-plate type beam splitter 522 is used as an optical path separation element for separating the return light beams of the respective laser beams from the emitted laser beam to guide to the light receiving element 40 for signal detection. Therefore, cost can be reduced in comparison with a case when two prisms are used as the optical path composing element and the optical path separation element.

Further, the aberration correction lens 50 for correcting the astigmatism and the coma aberration generated when the first laser beam obliquely transmits through the first parallel-plate type beam splitter 521, is disposed on the emitting side of the first laser light source 31. Further, in order to accurately align the aberration correction lens 50 with the first laser light source 31, the aberration correction lens 50 and the first laser light source 31 are fixed to the common holder 110 to structure a piece of the light source unit 100 and, after the position of the light source unit 100 has been adjusted, the light source unit 100 is adhesively bonded and fixed to the device frame 2. The astigmatism and the coma aberration of the first laser beam, which are generated when the first laser beam obliquely transmits through the first parallel-plate type beam splitter 521, are securely corrected by the aberration correction lens 50 that is structured as one unit with the first laser light source 31. Therefore, the aberration correction can be performed without using a conventional parallel-plate type beam splitter, which is thin and made of material whose hardness is high, as the beam splitter through which the light beam is transmitted. Accordingly, a satisfactory beam spot can be formed on the optical recording medium 5.

In addition, the light source unit 100 is mounted on the unit mounting part 25 of the device frame 2 in the state that the position of the light source unit 100 is capable of being three-dimensionally adjusted and, after its position has been three-dimensionally adjusted, the light source unit 100 is fixed to the device frame 2 with an adhesion. Therefore, residual aberration of the light source unit 100 can be securely reduced, and positional adjustment with the light receiving element 40 for detection can be accurately performed with a simple adjusting work.

In addition, the aberration correction lens 50 is disposed on the optical path directing to the first beam splitter 521 from the first laser light source 31. Therefore, the aberration correction lens 50 does not affect the second laser beam which is reflected by the first parallel-plate type beam splitter 521 and thus optical design of the aberration correction lens 50 can be easily performed.

Further, the incident angle θ1 of the first laser beam to the first beam splitter 521 is set to be less than 45° and thus a length of the optical path where the first laser beam transmits through the first beam splitter 521 is shortened. Since the first laser beam is incident on the first beam splitter 521 at an angle closer to the vertical incidence, aberration generated when the first laser beam transmits through the first beam splitter 521 can be reduced. Therefore, correcting quantity of the aberration which is performed by the aberration correction lens 50 can be reduced. Further, design of the toric lens which is used for the aberration correction lens 50 becomes easy.

Further, the toric lens which is used as the aberration correction lens 50 is also used, i.e., functions as a magnification conversion lens to the first laser beam. Therefore, a magnification conversion lens is not required to provide separately and thus cost can be further reduced.

In addition, when the incident angle θ1 of the first laser beam to the first beam splitter 521 is set to be less than 45°, the first and the second laser light sources 31 and 32 are disposed in a farther separated state even when a size of the device frame 2 is reduced. Therefore, mounting work of the first and the second laser light sources 31 and 32, positional adjustment work of the first and the second laser light sources 31 and 32, and the like can be performed easily. As a comparison example, when the incident angle θ1 of the first laser beam to the first beam splitter 521 is set to be 45°, emitting optical axes of the first and the second laser light sources 31 and 32 are parallel to each other and thus the laser light sources 31 and 32 are located to come near each other. However, when the incident angle θ1 of the first laser beam to the first beam splitter 521 is set to be less than 45°, the emitting beam axis of the second laser light source 32 is inclined to the direction where the laser light sources 31 and 32 are located further apart.

In the embodiment described above, the toric lens having the toric face 50b on its one face is used as the aberration correction lens 50, but a cylindrical lens may be used instead of using the toric lens. Further, both the coma aberration and the astigmatism are corrected by one piece of the aberration correction lens 50 but it may be structured that the coma aberration and the astigmatism are corrected by separate aberration correcting elements. In addition, in the embodiment described above, the aberration correction lens 50 is structured to have an aberration correction function and an optical magnification modification function. However, the aberration correction function and the optical magnification modification function may be respectively provided in separate optical elements.

The present invention may be applied to a single light source type optical head device. For example, in FIG. 2, an optical system may be structured which comprises the light source unit 100, the first diffraction grating 511, the first beam splitter 521, the directing mirror 53, the collimating lens 54, the objective lens 91, the light receiving element 45 for monitor, the detection lens 56, and the light receiving element 40 for signal detection. Also in this case, similarly to the case of the embodiment described above, cost of the optical system can be reduced and aberration of the laser beam which is generated when the laser beam transmits through the parallel-plate type beam splitter can be corrected securely.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device comprising:
a first laser light source for emitting a first laser beam;
a second laser light source for emitting a second laser beam whose wavelength is different from a wavelength of the first laser beam;
a first parallel-plate type beam splitter which is disposed so as to guide the first and the second laser beams to a common objective lens and to guide a return light beam component reflected by an optical recording medium through the common objective lens to a light receiving element;
a second parallel-plate type beam splitter which is disposed so as to guide the second laser beam to the common objective lens and to guide the return light beam component reflected by an optical recording medium through the common objective lens to the light receiving element;
a device frame on which the first and the second laser light sources and the first and the second beam splitters are mounted;
an aberration correction lens which is disposed between the first laser light source and the first beam splitter for correcting an aberration which is generated when the first laser beam transmits through the first beam splitter; and
a light source unit which is structured by fixing the first laser light source and the aberration correction lens to a common holder in a state that a relative position between the first laser light source and the aberration correction lens is previously set;
wherein the light source unit is adhesively bonded and fixed to a unit mounting part formed in the device frame in a positioned state;
wherein the first laser beam which is emitted from the first laser light source is partially transmitted through the first beam splitter in an oblique direction to be guided to the objective lens; and
wherein the second laser beam which is emitted from the second laser light source is sequentially reflected by the second beam splitter and the first beam splitter to be guided to the objective lens.

2. The optical head device according to claim 1, further comprising at least a piece of spacer which is provided in the light source unit for adjusting a distance between a light-emitting point of the first laser light source and a lens center of the aberration correction lens;
wherein at least one of the first laser light source and the aberration correction lens is fixed to the common holder through the spacer.

3. The optical head device according to claim 2, wherein
the light source unit which is to be mounted on the unit mounting part is movable in a direction of an optical axis of the light source unit, in a direction perpendicular to the optical axis, and around an axial line perpendicularly passing through the optical axis, and
the light source unit is adhesively bonded and fixed to the unit mounting part in a state that position of the light source unit mounted on the unit mounting part has been three-dimensionally adjusted.

4. The optical head device according to claim 3, wherein the aberration correction lens is a toric lens.

5. The optical head device according to claim 4, wherein the toric lens is provided with a function of a magnification conversion lens by which magnification from the first laser light source to the optical recording medium is set in a prescribed value.

6. The optical head device according to claim 4, wherein each of the return light beam components of the first laser beam and the second laser beam is reflected by the first beam splitter to be guided to the second beam splitter and then transmits through the second splitter to be guided to the light receiving element.

7. The optical head device according to claim 1, wherein
the light source unit which is mounted on the unit mounting part is movable in a direction of an optical axis of the light source unit, in a direction perpendicular to the optical axis, and around an axial line perpendicularly passing through the optical axis, and
the light source unit is adhesively bonded and fixed to the unit mounting part in a state that position of the light source unit has been three-dimensionally adjusted to the unit mounting part.

8. The optical head device according to claim 1, wherein the aberration correction lens is a toric lens.

9. The optical head device according to claim 8, wherein the toric lens is provided with a function of a magnification conversion lens by which magnification from the first laser light source to the optical recording medium is set in a prescribed value.

10. The optical head device according to claim 1, wherein each of the return light beam components of the first laser beam and the second laser beam is reflected by the first beam splitter to be guided to the second beam splitter and then transmits through the second splitter to be guided to the light receiving element.

11. The optical head device according to claim 1, wherein an incident angle of the first laser beam to the first beam splitter is set at an inclination angle less than 45°.

12. An optical head device comprising:
a laser light source for emitting a laser beam;
a parallel-plate type beam splitter which is disposed so as to guide the laser beam to an objective lens;
an aberration correction lens which is disposed between the laser light source and the beam splitter for correcting aberration which is generated when the laser beam transmits through the beam splitter; and
a light source unit which is structured by fixing the laser light source and the aberration correction lens to a common holder in a state that a relative position between the laser light source and the aberration correction lens is previously set;
wherein the light source unit is adhesively bonded and fixed to a unit mounting part formed in a device frame in a positioned state; and
wherein the laser beam which is emitted from the laser light source is partially transmitted through the beam splitter in an oblique direction to be guided to the objective lens; and
wherein a return light beam component of the laser beam is reflected by the beam splitter to be guided to a light receiving element for signal detection.

13. The optical head device according to claim 12, further comprising at least a piece of spacer which is provided in the light source unit for adjusting a distance between a light-emitting point of the laser light source and a lens center of the aberration correction lens;
wherein at least one of the laser light source and the aberration correction lens is fixed to the common holder through the spacer.

14. The optical head device according to claim 13, wherein
the light source unit which is to be mounted on the unit mounting part is movable in a direction of an optical axis of the light source unit, in a direction perpendicular to the optical axis, and around an axial line perpendicularly passing through the optical axis, and
the light source unit is adhesively bonded and fixed to the unit mounting part in a state that position of the light source unit has been three-dimensionally adjusted to the unit mounting part.

15. The optical head device according to claim 12, wherein
the light source unit which is to be mounted on the unit mounting part is movable in a direction of an optical axis of the light source unit, in a direction perpendicular to the optical axis, and around an axial line perpendicularly passing through the optical axis, and
the light source unit is adhesively bonded and fixed to the unit mounting part in a state that position of the light source unit has been three-dimensionally adjusted to the unit mounting part.

16. The optical head device according to claim 12, wherein the aberration correction lens is a toric lens.

17. The optical head device according to claim 12, wherein an incident angle of the laser beam to the beam splitter is set at an inclination angle less than 45°.
